(19) United States
(12) Patent Application Publication
(10) Pub. No.: US 2004/0177259 A1
(43) Pub. Date: Sep. 9, 2004

(54) Content protection system for optical data storage disc

(76) Inventor: Steven B. Volk, Boulder, CO (US)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/383,193

(22) Filed: Mar. 5, 2003

(51) Int. Cl. H04L 9/32

(52) U.S. Cl. 713/193; 713/201

(57) ABSTRACT

An optical data storage disc contains at least an “X data area” and a user data area, the latter of which may include for example a video game or a movie. The disc drive internally loads and runs a program (the “X program”) resident in the X data area before the user data is accessed. The X program may operate on data that are read from the disc or delivered by host device to the disc drive. The X program generates a result that is delivered to the interface between the disc drive and a host device (e.g., a cell phone or a PDA), and the host device reads the result and compares it with an expected result. If a predetermined correspondence exists, the disc drive is authorized to read the user data. If the predetermined correspondence does not exist, the user data cannot be read. The content of the X data area, including the X program, never appears at an interface between the disc drive and a host device (e.g., a cell phone or PDA). Thus even if the user data are copied onto another media, that media will not contain the X program, thereby preventing the user data from being read.

### FIELD OF THE INVENTION

This invention relates to optical data storage discs and in particular to a method for protecting the content of an optical data storage discs from unauthorized use.

### BACKGROUND OF THE INVENTION

The optical disc has become the preferred data storage device in today's economy. Among the reasons for this are the data capacity and permanence of optical discs. For example, a Compact Disc (CD) typically holds over 700 Mbytes and a Digital Versatile disc (DVD) can hold over 4 Gbytes. The life of an optical disc is exceedingly long (e.g., 100 years or more). In addition, optical discs are relatively inexpensive to manufacture and are easy to replicate.

Various types of digital content can be stored on optical data discs, including music, movies, video games, and audio books. One problem that has confronted the suppliers of such digital content has been the risk of copying (piracy). This problem can be overcome to some extent by encryption of the data on the disc. Encryption schemes are generally applied to a broad range of content, however, and therefore if a would-be copier is able to “crack” a single case of the encryption scheme they may obtain access to a wide variety of movies, video games, etc.

Another security technique involves using a code to restrict the use of a disc to a particular host device. Understandably, this technique is not popular with consumers, who wish to use their discs in any compatible host.

Alternatively, the user's access to the digital content may be restricted, for example, by requiring the user to enter and maintain an unlocking code. It has been found, however, that this tends to severely undercut the value of the entertainment content in the user's mind. In fact, recent studies have shown that consumer-visible security techniques actually encourage piracy.

Still other schemes rely on a security algorithm that is embedded in the disc drive. This requires that the algorithm be known to the manufacturer of the disc drive, which can be a security risk insofar as the disc manufacturer is concerned. Moreover, if the algorithm is discovered, it cannot easily be changed.

### SUMMARY OF THE INVENTION

An optical data storage disc used in the method of this invention includes a user data area and a private data area, the latter being referred to herein as the “X data” area. The user data area includes any data that is to be used by a user and may include entertainment content, such as a video game, a movie, a recorded television program or an audio book. At least a portion of the X data area constitutes one or more programs, referred to herein collectively as the “X program.” In addition, the X data area may include data that are associated with the X program. The disc is read by a disc drive which contains a microprocessor and which is connected through an interface to a host device such as a personal digital accessory (PDA), a cell phone or a laptop personal computer (PC). Only the disc drive can read the X data. None of the data in the X data area—either the data constituting the X program or the associated data, if any—are ever present at the interface between the disc drive and the host device.

In one embodiment, the host device presents an “X data execute command” to the interface with the disc drive. The X data execute command causes the disc drive to read the X program, and the internal microprocessor thereupon executes the X program. The X program may operate on certain data that the microprocessor reads from specified areas of the disc, e.g., the user data area and the X data area. The execution of the X program produces a “result” that the disc drive delivers to the interface.

The host runs a function that is complementary to the X program to generate an “expected result”.

The host then compares the result with an expected result and if and only if a predetermined correspondence is detected between the result and the expected result, the host is allowed to read the entertainment content or other data in the user data area.

As indicated, the X program is never present at the interface between the disc drive and the host device and cannot be read by the host device. Therefore, if a person copies the user data from the disc to another media—for example another disc or a flash card—the X program would be missing. When the application attempted to read the unauthorized copy, no “result” would be forthcoming from the media for comparison, and the application would refuse to read the media.

The method of this invention has many variations. For example, the host may present an argument to the disc drive along with the X data execute command, and the disc drive may execute the X program, using the argument, to generate the result. The disc typically contains a system data area and may also contain an area reserved for vendor-specific data that is accessible by vendor-specific read commands. The data on which the X program operates may also be read from those areas. The X program may be expressed in the disc drive microprocessor's native machine language, or the microprocessor may to used to implement a “virtual machine” using an internal ROM-based code. Such a virtual machine allows a variety of microprocessors to be used in various disc drives while maintaining compatibility with pre-existing discs with X programs as well as future discs with X programs. The virtual machine may includes an AWK, Basic, JAVA, Perl and Visual Basic interpreter.

By using X programs stored on the disc instead of programs stored in the disc drive's embedded memory (such as its ROM) each content provider's discs may have a unique content protection scheme. As a result, an attack on one content provider's scheme will not imply a breach of the security provided by another scheme. In addition, the method of this invention does not require any secret keys, global or otherwise, so there is no need for a “Certificate Authority” as the basis for participating in the security system. The method is completely transparent to the user; he or she simply connects the disc drive to the host device and plays the disc. The security method of this invention does not preclude the use of additional encryption and other digital rights management (DRM) schemes.

### BRIEF DESCRIPTION OF THE DRAWINGS

FIG. 1 is a block diagram illustrating the structure of a disc drive in accordance with the invention.

FIG. 2 is a schematic diagram of the structure of a disc in accordance with the invention.

FIG. 3 is a schematic block diagram of the disc inside in the disc drive connected to a host device, and the data flow between the system components.

FIGS. 4A and 4B illustrate a flow chart of the method of this invention.

FIG. 5 is a block diagram of the inputs and outputs to and from the disc drive's microprocessor (virtual machine).

### DESCRIPTION OF THE INVENTION

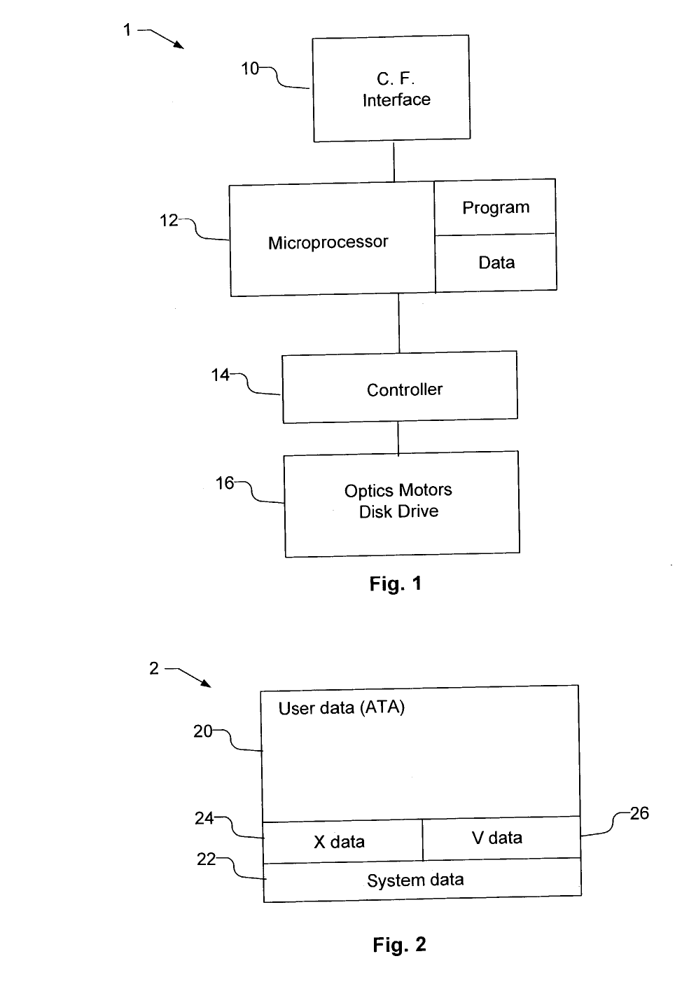

FIG. 1 is schematic block diagram of an exemplary disc drive 1, disc drive 1 includes an interface 10 that is compatible with a corresponding interface (not shown) on a host device, such as a PDA, cell phone or laptop PC. In this embodiment, interface 10 fits the standard Compact Flash™ slot that is found in many such host devices, disc drive 1 also includes a microprocessor 12 that normally includes a random access memory (RAM) and read-only memory (ROM) for programs and data, a controller 14 and optics motors 16. Microprocessor 12 could be, for example, the ST10 manufactured by ST Microelectronics.

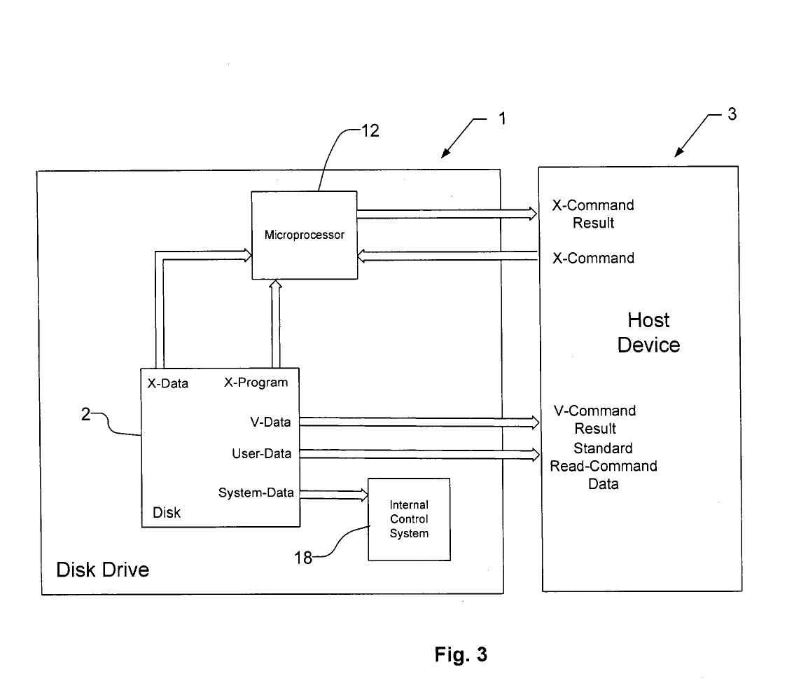

FIG. 2 shows a schematic diagram of the content of a typical optical data storage disc 2 that could be inserted into disc drive 1. As indicated, disc 2 includes two conventional data storage areas, designated user data 20 and system data 22. User data 20 contains the main content of disc 2, e.g., a video game or a movie or recorded TV program. This content is referred to herein as the “entertainment content,” although it will be understood that user data 20 may include any type of data. System data 22 contains data that are used to control and administer the operation of the disc drive 2.

Optical disc 2 also contains an area referred to as X data 24. X data 24 includes a program or programs (designated herein collectively as the “X program”) that, according to the invention, are loaded and invoked upon presentation of an X data execute command to the disc drive. Disc drive 1 can read X data 24 but will not output or reveal X data 24 at the interface 10. Thus, X data 24 are not copyable or visible by means of an ordinary file search.

Optical disc 2 may also contain vendor-specific data (V data) 26, which are data accessible by vendor-specific read commands. V data 26 may be in a proprietary format or encrypted. Anyone who knows the V data read commands can read the V data 26, although V data 26 are not ordinarily visible or file copyable. One example of V data 26 is information stored on a disc during a disconnected self test and retrieved later during a connected part of the test process.

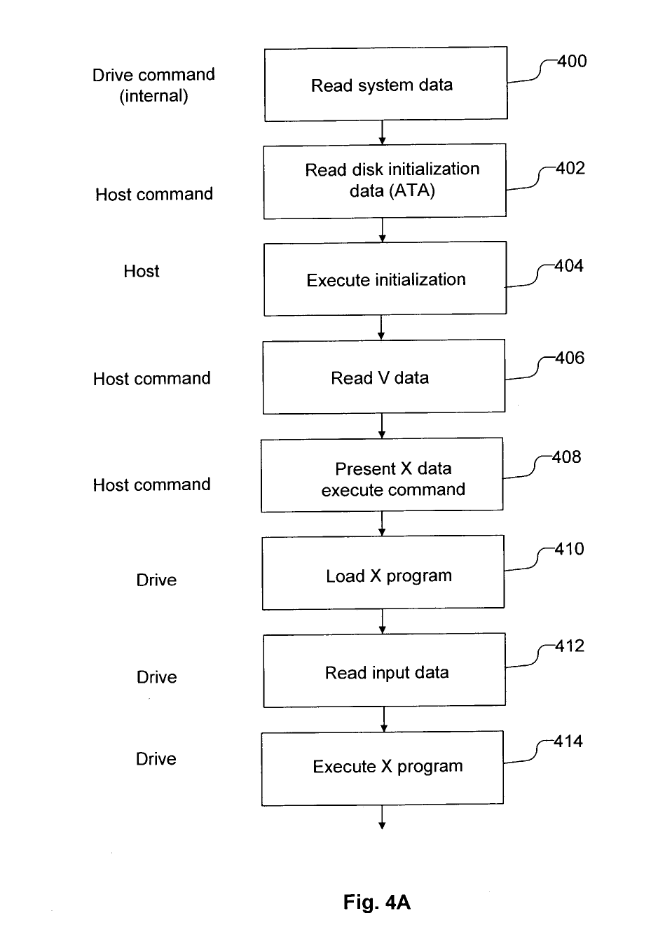

FIG. 3 shows disc drive 1 connected to a host device 3, which may be a personal digital accessory (PDA), a cell phone or a laptop personal computer (PC). In addition to the components previously described, disc drive 1 contains an internal control system 18, which reads and responds to system data 22 on disc 2. It is understood that the internal control system 18 may be implemented using the microprocessor 12.

Host device 3 presents an “X data execute command” to interface 10. In response to the X data execute command, microprocessor 12 reads the data which constitute the X program from X data 24. Typically, microprocessor 12 also reads other data on which the X program operates (referred to herein as “input data”), which may be stored in the user data 20, X data 24, or V data 26 (see FIG. 2). The input data may or may not be encrypted. The input data upon which the X program operates may also include an argument provided to interface 10 by host device 3 along with the X data execute command.

Using the input data, microprocessor 12 then executes the X program and delivers the “result” to interface 10.

The application that is running in host device 3 contains a function that is complementary to the X program, and it runs that program to obtain an “expected result.” In one embodiment, the complementary function is based on the same algorithm as the X program, and the input data are available in the application that is running in the host device. Therefore, the host device 3 computes an “expected result” that is identical to the result that is generated by the X program.

Host device 3 reads the result and compares it with an expected result. If and only if the requisite correspondence exists between the result and the expected result (either a direct match or some other relationship) host device 3 authorizes drive 1 to read and decode user data 20 of disc 2, which typically include entertainment content. The entertainment content within user data 20 may or may not be encrypted. To read the user data 20, host device 3 typically transmits a standard (ATA) read command to disc drive 1. (The standard (ATA) read command is drawn from a command set promulgated by ANSI Technical Committee T13, which is responsible for all interface standards relating to the popular AT Attachment (ATA) storage interface utilized as the disc drive interface on most personal and mobile computers today. The ATA command set is supported by the Compact Flash interface for Compact Flash-attached disc drives.)

If the requisite correspondence between the result provided to interface 10 by disc drive 1 and the expected result held by host device 3 is not present, the application program operating in host device 3 terminates or host device 3 is otherwise precluded from reading user data 20.

Since the X program is read from the disc, it need not be known by the manufacturer of the disc drive and can be changed from disc to disc. These features provide additional security and flexibility as compared with prior art systems which rely on a program that is embedded in the disc drive.

The X data execute command and a means of generating the expected result reside in the application that is running in host device 3 (e.g., a “media player” used to view a movie). The X data execute command is typically not a standard disc drive command but rather is a command designed for the specific purpose of causing microprocessor 12 to read and execute the X program. In some situations, the X data execute command and expected result are loaded from disc 2 into host device 3 or derived from the host program; this is frequently the case, for example, where disc 2 contains a video game. In other situations, the X data execute command resides permanently in the host application; this would normally be the case if, for example, the application is a media player.

The X program may take a wide variety of forms. In some situations, the X program may simply be a lookup function which causes the disc drive's microprocessor to read data from the disc and deliver it to the interface. The host application knows what data to expect and compares the data delivered by the drive with the expected data. In one variant of this, the host application may deliver to the interface a pointer to an address on the disc where the expected result is held. The drive then reads the expected result from the disc and delivers it to the interface. Conversely, the X program may command the microprocessor to read data from the disc and deliver the data to the host device along with a pointer to a memory location in the host device where the expected result is held. The host device then compares the expected data read from its own memory with the data delivered by the drive. In all of these alternatives, the data and/or pointer delivered to the interface may be encrypted.

As shown in FIG. 3, host device 3 may also read vendor-specific data (V data) from disc 2 by transmitting a V command to disc drive 1.

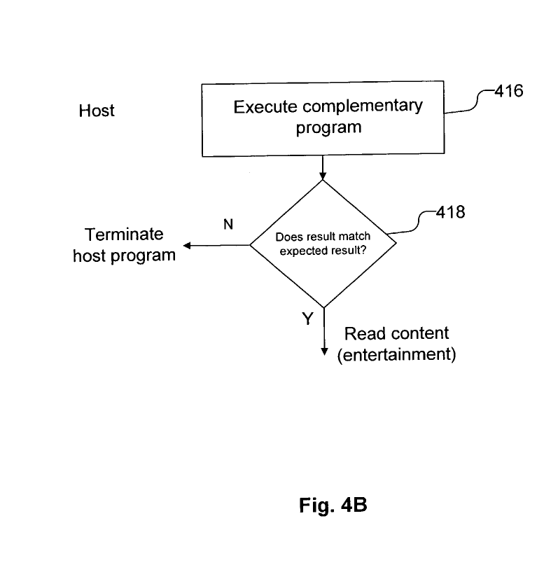

FIGS. 4A and 4B illustrate the process of this invention in flow chart form. After disc 2 has been inserted in disc drive 1 and disc drive 1 has detected the presence of disc 2, drive 1 reads system data 22, which describe the data structure of disc 2 (step 400). After this has been completed, disc drive 1 notifies host device 3 that it is “Ready.” Host device 3 typically commands disc drive 1 to read certain initialization data from user data (ATA) of disc 2 (step 402), after which host device 3 executes an initialization procedure (step 404). Host device 3 reads the application from vendor-specific data from V data 26 or user data 20 of disc 2, or from other memory in the system (step 406). Host device 3 initiates the application (step 407). Host device 3 issues an X data execute command to disc drive (step 408), which instructs microprocessor 12 inside disc drive 1 to load the X program from X data 24 and to initiate the X program. As noted above, the X program may run on a virtual machine implemented by microprocessor 12, using a ROM stored in the memory of microprocessor 12.

In response to the X data execute command, drive 1 loads the X program (step 410) and the input data upon which the X program will operate (step 412). The input data may be stored in various areas of disc 2—for example, in user data 20, X program data 24 or V data 26—and it may include an argument that is delivered to disc drive 1 by host device 3 along with the X data execute command.

Microprocessor 12 executes the X program to arrive at a result and delivers the result to interface (step 414). Host device 3 executes a complementary program to generate an expected result and compare the expected result with the result (step 416). If the result and expected result match or are in some other predetermined relationship (step 418), host device 3 is authorized to read and execute the entertainer content in user data 20, which may be a video game, a movie or some other form of entertainment. If the result and the expected result are not in the predetermined relationship, the host device is not authorized to read the entertainment content and, for example, the host program may terminate.

While this procedure will normally occur when the disc is initially placed in the disc drive, it will be apparent that it can also be run periodically while the disc is being played to verify that the disc is present and is not an unauthorized copy. It will also be apparent that this procedure can be used to decode and/or encode any or all of the user data 20 and/or V data 26 for delivery to the host. It will also be apparent that the X data may include multiple X programs, in which case the particular X program to execute is specified by a parameter included in the X data execute command.

To illustrate the operation of the content protection system, suppose that user data 20 (e.g., entertainment content) is read from disc 1 and copied onto another storage device, such as an optical disc. If the person who made the copy attempts to read the copied data, the application running in the host device will issue an X data execute command to the disc drive. Since the X program is not present on the disc, the disc drive will not respond to the X data execute command. No “result” will be forthcoming from the disc drive. When the host device attempts to compare the “result” with the expected result, the requisite correspondence will not occur, and therefore the host device will not be authorized to read the user data from the copied disc.

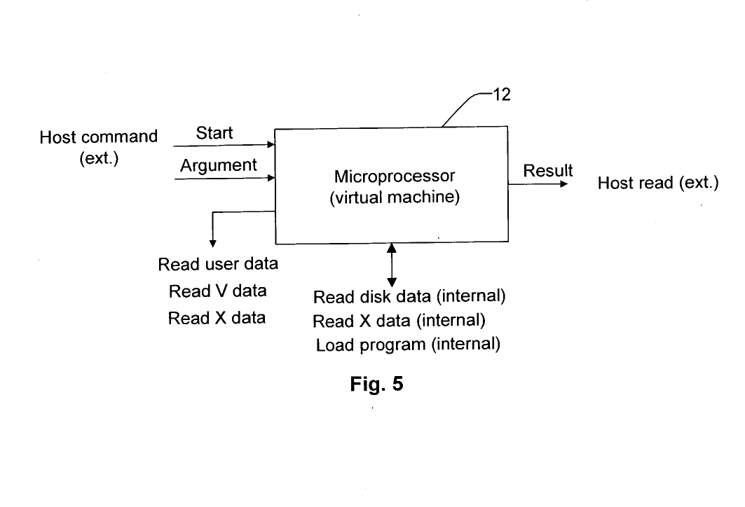

FIG. 5 is a block diagram showing the inputs and outputs of microprocessor 12.

Several examples will help to illustrate the principles of the invention.

### EXAMPLES

### Example 1

A video game resident in the host device generates and retains a random or pseudo-random number and delivers the random or pseudo-random number (hereinafter referred to as “random number”) to the disc drive interface, where it is read by the disc drive. The X program running in the disc drive executes a one-way function and returns the encrypted value to the host device. The video game executes the same function and compares its encrypted value to the value received from the disc drive. Since the X data (from which the X program is read) cannot be copied, a disc that contains data copied from a genuine original disc will fail this test.

### Example 2

This example in addition uses asymmetric or public-private key encryption to establish a secure session. A random number generator and a public key function are implemented in both the application running in the host device (e.g., a video game) and in the X program. The game sends its public key to the drive, and the X program sends its public key to the game. Each side generates and retains a different random number, encrypts its random number with other side's public key, and delivers its encrypted random number to the other side. Each side decrypts the received value. As a result, both sides have both random numbers. Thus a “secure session” has been established. The combination of these random numbers is the session key and is a shared secret. Delivery of the content decryption key can now easily occur under encryption by the session key.

To summarize, using the method of this invention, the copying of data from an optical disc to another data storage device, for example a flash card or another optical disc, can effectively be prevented. The method is transparent to the user and requires no special actions on the user's part.

While specific embodiments of this invention have been described, it will be understood that these embodiments are illustrative and not limiting. Many other embodiments that fall with the broad scope of this invention will be apparent to those of skill in the art. For example, in some embodiments the X data execute command may be omitted. Instead, the microprocessor in the disc drive may execute the X program automatically after the initialization process has been performed and then deliver the result to the interface the with the host device.

I claim:

1. A method for reading data from an optical data storage disc, said disc being mounted to a disc drive, said disc drive being connected to a host device, wherein said disc comprises a user data area and an X data area, said user data area containing entertainment content, said X data area containing at least one X program, said method comprising:
providing an X data execute command in said host device;
causing said host device to present said X data execute command to said disc drive; and
in response to said X data execute command, causing a microprocessor within said disc drive to read said at least one X program from said X data area and to execute said at least one X program, thereby generating a result.

2. The method of claim 1 further comprising:
providing an expected result in said host device;
causing said disc drive to present said result to said host device;
determining whether a predetermined relationship exists between said result and said expected result; and
allowing said host device to read said entertainment content if and only if said preselected relationship exists.

3. The method of claim 1 wherein causing said microprocessor to execute said at least one X program comprises causing said at least one X program to operate on input data.

4. The method of claim 3 comprising causing said microprocessor to read said input data from at least one of said user data area, said X data area and a vendor-specific area of said disc.

5. The method of claim 4 wherein said input data comprises an argument presented to said disc drive by said host device.

6. The method of claim 1 wherein at least a portion of said input data is encrypted.

7. The method of claim 1 wherein at least a portion of said entertainment content is encrypted.

8. The method of claim 1 wherein said X data execute command is resident in an application in said host device.

9. The method of claim 5 wherein said X data execute command is present on said disc and said method comprises reading said X data execute command from said disc to said application.

10. The method of claim 1 comprising:
presenting an argument to said disc drive; and
causing said microprocessor to execute said at least one X program using said argument.

11. The method of claim 1 wherein said entertainment content comprises a video game.

12. The method of claim 1 wherein said entertainment content comprises a movie.

13. The method of claim 1 wherein said entertainment content comprises a recorded television program.

14. The method of claim 1 wherein said entertainment content comprises an audio book or viewable book.

15. The method of claim 1 wherein said host device is a personal digital accessory (PDA).

16. The method of claim 1 wherein said host device is cell phone.

17. The method of claim 1 wherein said host device is a laptop personal computer (PC).

18. The method of claim 1 wherein said disc comprises a vendor-specific data area.

19. The method of claim 1 comprising causing said microprocessor to read a ROM-based code to implement a virtual machine.

20. The method of claim 19 wherein said virtual machine includes an interpreter selected from the group consisting of AWK, Basic, JAVA, Perl and Visual Basic interpreters.

21. The method of claim 1 wherein said at least one X program is never present at an interface between said host and said disc drive.

22. The method of claim 1 comprising:
causing said host device to generate a random number;
causing said host device to deliver said random number to said disc drive; and
causing said X program to operate on said random number as input data.

23. The method of claim 1 comprising:
causing said host device to generate a first random number;
causing said drive to generate a second random number;
delivering a host public key to said drive;
delivering a drive public key to said host;
causing said host to encrypt said first random number with said drive public key, thereby generating an encrypted first random number;
causing said drive to encrypt said second random number with said host public key, thereby generating an encrypted second random number;
causing said host to deliver said encrypted first random number to said drive;
causing said drive to deliver said encrypted second random number to said host; and
causing said host to decrypt said encrypted second random number;
causing said drive to decrypt said encrypted first random number; and
combining said first and second random numbers to form a session key.

24. The method of claim 1 comprising establishing a secure session between said host device and said disc drive.

25. The method of claim 24 wherein establishing a secure session comprises;
causing said host device and said disc drive to generate first and second random numbers, respectively;
causing said host device to transmit a host public key to said disc drive and causing said disc drive to transmit a drive public key to said host device;
causing said host device to encrypt said first random number with said drive public key to produce a first encrypted random number;
causing said disc drive to encrypt said second random number with said host public key to produce a second encrypted random number; and
causing said host to transmit said first encrypted random number to said disc drive and causing said disc drive to transmit said second encrypted random number to said host device.

26. The method of claim 25 comprising:
causing said host device to decrypt said second encrypted random number using the host device's private key so as to obtain said second random number; and
causing said disc drive to decrypt said first encrypted random number using the disc drive's private key so as to obtain said first random number.

27. The method of claim 26 comprising causing each of said host device and said disc drive to combine said first and second random numbers so as to generate a shared secret for the secure session.

28. A method for reading data from an optical data storage disc, said disc being mounted to a disc drive, said disc drive being connected to a host device, wherein said disc comprises a user data area and an X data area, said user data area containing entertainment content, said X data area containing at least one X program, said method comprising:
causing a microprocessor within said disc drive to read said at least one X program from said X data area;
causing said microprocessor to execute said at least one X program, thereby generating a result;
causing said disc drive to present said result to said host device;
determining whether a predetermined relationship exists between said result and said expected result; and
allowing said host device to read said entertainment content if and only if said preselected relationship exists.
